(19) United States
(12) Patent Application Publication
(10) Pub. No.: US 2019/0087069 A1
(43) Pub. Date: Mar. 21, 2019

(54) TILING CONTENT FOR PRESENTATION ON DIFFERENT DISPLAY SIZES

(71) Applicant: Rockwell Automation Technologies, Inc., Mayfield Heights, OH (US)

(72) Inventor: John H. McCauley, Germantown, WI (US)

(21) Appl. No.: 15/711,577

(22) Filed: Sep. 21, 2017

(51) Int. Cl. G06F 3/0481; G05B 19/042; G06F 3/0484; G06F 9/44

(52) U.S. Cl. CPC G06F 3/04817; G06F 9/4443; G06F 3/04847; G05B 19/0426

(57) ABSTRACT

Techniques to facilitate visualization of an application associated with an industrial automation environment are disclosed. In at least one implementation, a display composer interface comprising tiles arranged in a grid is presented that enables a user to design a customized display layout for the application associated with the industrial automation environment. Display position instructions are received that indicate an arrangement of data items over the tiles on the grid of the display composer interface, wherein the data items are associated with industrial automation operations. The display position instructions are processed to generate the customized display layout for the application. Based on the customized display layout, a graphical user interface is rendered to the application having the data items positioned according to the display position instructions, wherein the arrangement of the data items over the tiles dictates how the data items are positioned for a particular display size and orientation.

### TECHNICAL FIELD

Aspects of the disclosure are related to computing hardware and software technology, and in particular to industrial automation applications.

### TECHNICAL BACKGROUND

Industrial automation environments utilize machines during the industrial manufacturing process. These machines typically have various moving parts and other components that continually produce operational data over time, such as pressure, temperature, speed, and other metrics. Reviewing and monitoring this operational data is of high importance to those involved in operating the industrial automation environment.

In some cases, the operational data may be provided for display on a variety of systems and devices, such as notebook or tablet computers running standalone applications, web browsers, and the like, in order to present the information to the user. For example, a tablet computer could receive a constant stream of the operational data over a network and display this information dynamically, such as by providing live tiles, icons, charts, trends, and other graphical representations which continually receive updated operational data from external data sources, which are typically located in the industrial automation environment.

### Overview

Provided herein are systems, methods, and software to facilitate visualization of an application associated with an industrial automation environment. In at least one implementation, a display composer interface comprising tiles arranged in a grid is presented that enables a user to design a customized display layout for the application associated with the industrial automation environment. Display position instructions are received that indicate an arrangement of data items over the tiles on the grid of the display composer interface, wherein the data items are associated with operations of the industrial automation environment. The display position instructions are processed to generate the customized display layout for the application. Based on the customized display layout, a graphical user interface is rendered to the application having the data items positioned according to the display position instructions, wherein the arrangement of the data items over the tiles dictates how the data items are positioned for a particular display size and orientation.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a block diagram that illustrates an industrial automation environment in an exemplary implementation.

FIG. 2 is a flow diagram that illustrates an operation of a computing system in an exemplary implementation.

FIGS. 3-9 are block diagrams that illustrate various operational scenarios involving computing systems in industrial automation environments in exemplary implementations.

FIG. 10 is a block diagram that illustrates a computing system in an exemplary implementation.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Implementations disclosed herein provide for improved visualizations of information items associated with applications executing on a computing system. In one implementation, an application associated with an industrial automation environment may display a graphical user interface showing one or more data items related to industrial operations. For example, the graphical user interface could display data items such as key performance indicators (KPIs) related to operational data associated with machines in the industrial automation environment, such as parameters, pressures, temperatures, speeds, production rates, or some other status metrics. In some examples, the operational data for some KPIs may comprise dynamic charts or trends, real-time video, or some other graphical content.

By interacting with the graphical user interface, a user may utilize a display composer to select one or more of the data items for display by the application. In some implementations, the display composer interface comprises tiles arranged in a grid. Along with the selection of the data items, the user may also provide position instructions that identify where on the screen to display each of the selected items by indicating an arrangement of the data items over the tiles on the grid of the display composer interface. The arrangement of the data items over the tiles can then dictate how the data items are positioned for a particular display size and orientation. In some implementations, the user can also define the size, shape, display style (i.e., gauge, trend, chart, indicator, or some other display type), and other properties of each data item that is selected for display. In this manner, the user is able to create a customized display screen that presents the selected manufacturing data in the arrangement and style desired by the user, which may then be automatically formatted for display on a particular display size and orientation based on the arrangement of the data items over the tiles on the grid defined in the display position instructions. This custom display layout can be saved so that the visualization of the data as defined by the user may be presented at a later time. When viewing the user-defined display, the application may provide a “live feed” of dynamic KPI data for display according to the arrangement, style, and other properties defined by the user. This feed of dynamic KPI data may be continuously updated by the application so that the visualization of the KPI displayed shows the most current information associated with the KPI.

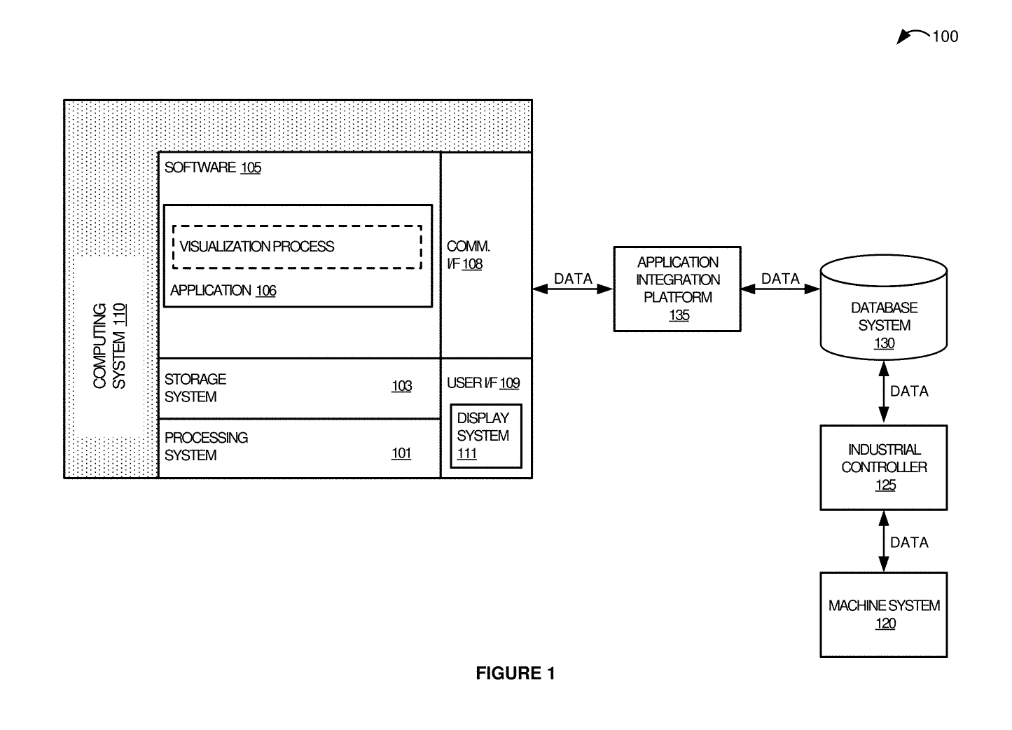

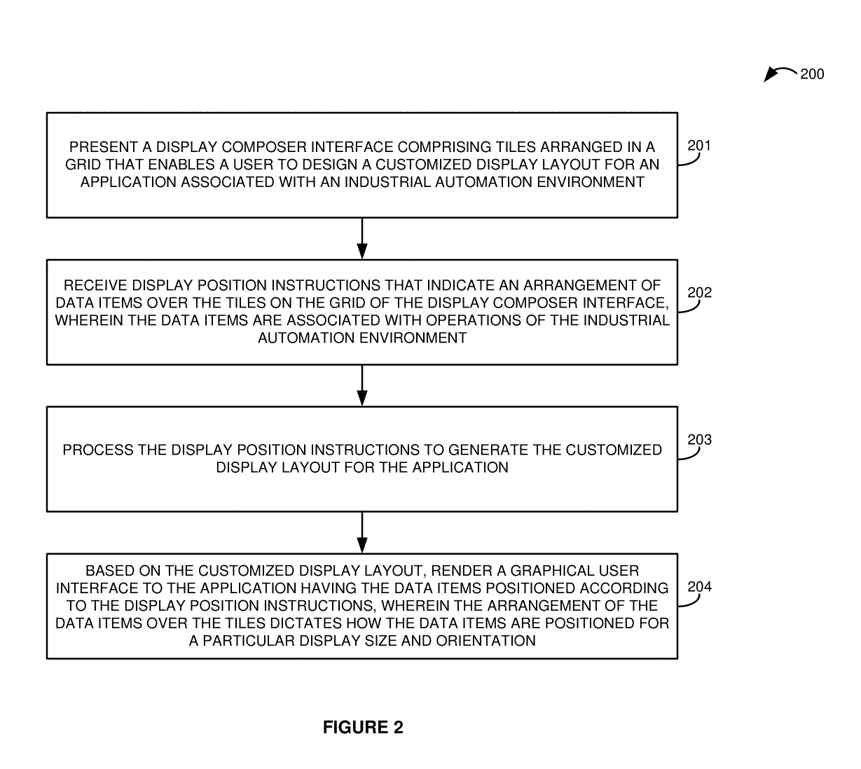

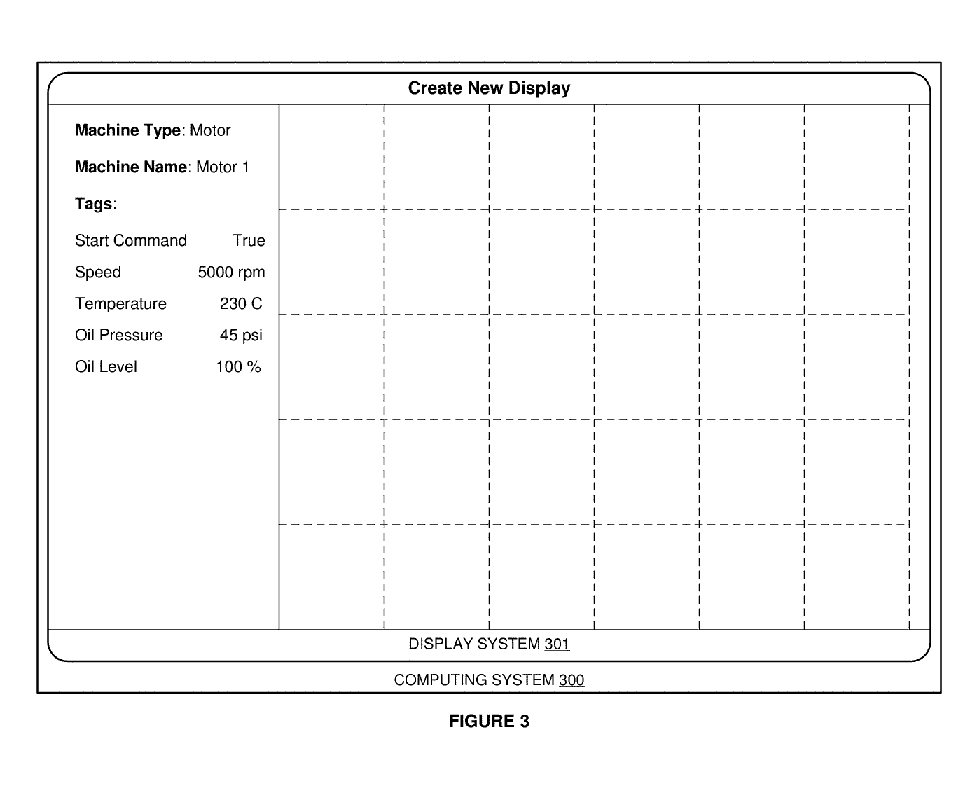

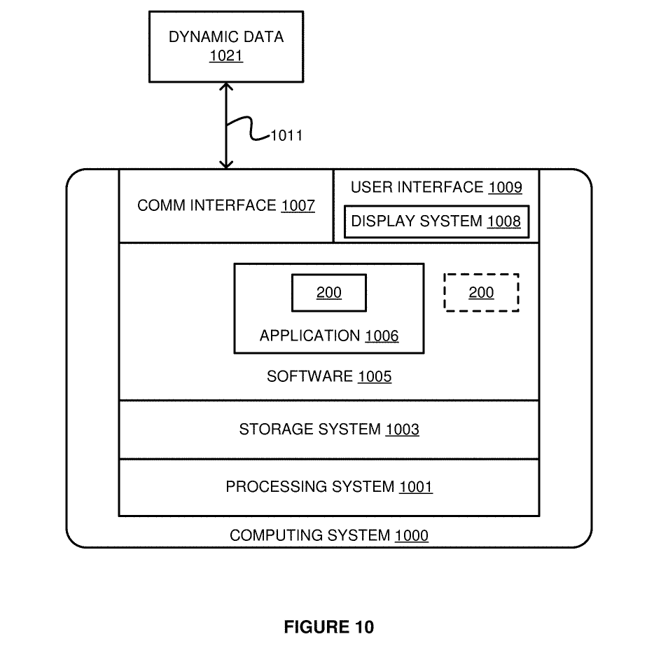

Referring now to the drawings, FIG. 1 illustrates an exemplary industrial automation environment that includes a computing system that may be used to execute an application and its visualization process, and FIG. 2 illustrates an operation of a computing system in an exemplary implementation. FIGS. 3-9 illustrate various operational scenarios involving computing systems according to several exemplary implementations. FIG. 10 illustrates an exemplary computing system that may be used to perform any of the visualization processes and operational scenarios described herein.

Turning now to FIG. 1, a block diagram that illustrates an industrial automation environment 100 in an exemplary implementation is shown. Industrial automation environment 100 provides an example of an industrial automation environment that may be utilized to implement the visualization processes disclosed herein, but other environments could also be used. Industrial automation environment 100 includes computing system 110, machine system 120, industrial controller 125, database system 130, and application integration platform 135. Machine system 120 and controller 125 are in communication over a communication link, controller 125 and database system 130 communicate over a communication link, database system 130 and application integration platform 135 communicate over a communication link, and application integration platform 135 and computing system 110 are in communication over a communication link. Note that there would typically be many more machine systems in most industrial automation environments, but the number of machine systems shown in FIG. 1 has been restricted for clarity.

Industrial automation environment 100 comprises an automobile manufacturing factory, food processing plant, oil drilling operation, microprocessor fabrication facility, or some other type of industrial enterprise. Machine system 120 could comprise a sensor, drive, pump, filter, drill, motor, robot, fabrication machinery, mill, printer, or any other industrial automation equipment, including their associated control systems. A control system comprises, for example, industrial controller 125, which could include automation controllers, programmable logic controllers (PLCs), or any other controllers used in automation control. Additionally, machine system 120 could comprise other industrial equipment, such as a brew kettle in a brewery, a reserve of coal or other resources, or any other element that may reside in an industrial automation environment 100.

Machine system 120 continually produces operational data over time. The operational data indicates the current status of machine system 120, such as parameters, pressure, temperature, speed, energy usage, operational equipment effectiveness (OEE), mean time between failure (MTBF), mean time to repair (MTTR), voltage, throughput volumes, times, tank levels, or any other performance status metrics. The operational data may comprise dynamic charts or trends, real-time video, or some other graphical content. Machine system 120 and/or controller 125 is capable of transferring the operational data over a communication link to database system 130, application integration platform 135, and computing system 110, typically via a communication network. Database system 130 could comprise a disk, tape, integrated circuit, server, or some other memory device. Database system 130 may reside in a single device or may be distributed among multiple memory devices. Database system 130 may be omitted in some implementations.

Application integration platform 135 comprises a processing system and a communication transceiver. Application integration platform 135 may also include other components such as a router, server, data storage system, and power supply. Application integration platform 135 may reside in a single device or may be distributed across multiple devices. Application integration platform 135 may be a discrete system or may be integrated within other systems—including other systems within communication system 100. In some examples, application integration platform 135 could comprise a FactoryTalk® VantagePoint server system provided by Rockwell Automation, Inc.

Computing system 110 may be representative of any computing apparatus, system, or systems on which the visualization processes disclosed herein or variations thereof may be suitably implemented. Computing system 110 provides an example of a computing system that could be used as a either a server or a client device in some implementations, although such devices could have alternative configurations. Examples of computing system 110 include mobile computing devices, such as cell phones, tablet computers, laptop computers, notebook computers, and gaming devices, as well as any other type of mobile computing devices and any combination or variation thereof. Examples of computing system 110 also include desktop computers, server computers, and virtual machines, as well as any other type of computing system, variation, or combination thereof. In some examples, computing system 110 could comprise a PanelView® graphic terminal provided by Rockwell Automation, Inc.

Computing system 110 includes processing system 101, storage system 103, software 105, communication interface 108, and user interface 109. Processing system 101 is operatively coupled with storage system 103, communication interface 108, and user interface 109. Processing system 101 loads and executes software 105 from storage system 103. Software 105 includes a visualization process. When executed by computing system 110 in general, and processing system 101 in particular, software 105 directs computing system 110 to operate as described herein for a visualization process or variations thereof. Computing system 110 may optionally include additional devices, features, or functionality not discussed here for purposes of brevity. An exemplary operation of computing system 110 to facilitate visualization of an application associated with an industrial automation environment will now be discussed with respect to FIG. 2.

FIG. 2 is a flow diagram that illustrates an operation 200 in an exemplary implementation. The operation 200 shown in FIG. 2 may also be referred to as visualization process 200 herein. The steps of the operation are indicated below parenthetically. The following discussion of operation 200 will proceed with reference to computing system 110 of FIG. 1 in order to illustrate its operations, but note that the details provided in FIG. 1 are merely exemplary and not intended to limit the scope of process 200 to the specific implementation shown in FIG. 1.

Operation 200 may be employed to operate a computing system to facilitate visualization of an application associated with an industrial automation environment, such as industrial automation environment 100 of FIG. 1. Operation 200 may be performed by computing system 110, although operation 200 could be executed by any system or device in some implementations. As shown in the operational flow of process 200, computing system 101 presents a display composer interface comprising tiles arranged in a grid that enables a user to design a customized display layout for an application associated with an industrial automation environment (201). In some examples, the display composer interface provides a visualization layout editor for the user to customize the display of an industrial automation application. For example, the user may utilize the display composer interface to select desired data items for viewing and the display types/styles for presenting that data, along with the arrangement of the various data items and their display types in order to create a customized display layout. In at least one implementation, the display composer interface provides at least one selection menu and a display canvas comprising tiles arranged in a grid for designing the customized display layout. The size of the tiles may vary from implementation to implementation, but in at least one example, the size of each tile could be set to about one half of the display size of the smallest target device. The grid of tiles provides a virtual framework for the user to arrange the various data items for the display layout, and this arrangement may then be utilized to determine how the data items may be positioned for a particular display size and orientation. In some implementations, the display composer interface could provide selection menus involving both a model toolbox panel menu for selecting various data items and a widget toolbox panel menu for selecting different data display types, such as value boxes, indicators, gauges, and the like. The user can then either drag a particular data display type from the widget toolbox panel to the display canvas to create a display item of a particular type, and then assign a specific data item to that display type, or the user can drag a data item from the model toolbox panel menu to the canvas, in which case a default display type will be created for the selected data item and to which the data item will automatically be assigned. Note that data items may also be referred to as graphical elements herein. Other implementations and functionality of the display composer interface are possible and within the scope of this disclosure.

After presenting the display composer interface, computing system 110 receives display position instructions that indicate an arrangement of data items over the tiles on the grid of the display composer interface, wherein the data items are associated with operations of the industrial automation environment (202). As discussed above, the display canvas comprises a grid of tiles for designing the customized display layout, which provides the user with a placement guide for positioning the various data items. For example, each of the data items are placed separately over one or more of the tiles on the grid of the display composer interface for the arrangement of the data items. To provide the display position instructions, a user could drag a data item from a selection menu to a display canvas area of the display composer interface and position the data item as desired over the tiles on the grid. In this manner, the display position instructions indicate the desired display locations for the data items as indicated by the user.

In at least one implementation, the display position instructions that indicate the arrangement of the data items over the tiles on the grid could include data items comprising one or more key performance indicators (KPIs) related to industrial operations, such as KPIs related to operational data associated with machine system 120 of industrial automation environment 100, such as parameters, pressures, temperatures, speeds, production rates, or some other status metrics. In some examples, the data items could be associated with a type of machine operating in the industrial automation environment, such as a pump, motor, extruder, or any other type of machine system. Further, in at least one implementation, the data items could comprise a control mechanism that controls an operation of a machine in the industrial automation environment. For example, the data items could include machine instructions for controlling the operation of one or more machines, such as a button configured to send control instructions to start or stop a machine, a control mechanism to transmit instructions to an industrial controller to direct the movement of a machine, or any other control data. The data items could also comprise human-machine interface (HMI) content associated with the operation of an HMI system, which could include various performance metrics, machine operational status reports, KPIs, control mechanisms, buttons, charts, trend diagrams, documents, or any other content associated with the operations of the industrial automation environment.

The user can arrange several data items over the tiles on the grid of the display composer interface to create a customized display layout. Each data item selected by the user in the display position instructions may include an associated data display type, such as indicators, value boxes, gauges, plots, trends, charts, grids, visualizations of vessels such as tanks or vats, or any other data visualization types. In some examples, the data display types for some data items may comprise dynamic charts or trends, real-time video, or some other live graphical content. Further, in some implementations, the user can also define the size, shape, display style (i.e., gauge, trend, chart, indicator, value box, or some other display type), and other properties of each data item that is arranged over the tiles on the grid for display in the display position instructions. For example, the user could select the desired data display type when providing the display position instructions, such that receiving the display position instructions comprises receiving a data display type for displaying the data items. Further, in some implementations, receiving the display position instructions could comprise receiving display size instructions for the data items. For example, the display size instructions could indicate the size of an associated data display type for each of the data items selected by the user in the display position instructions. In addition to the above, other customized properties and layout design options may be included in the data display instructions are within the scope of this disclosure.

In at least one implementation, the tiles on the grid of the display composer interface could be used to define the display size of the data items placed thereon. For example, the size of the tiles may be defined in terms of physical units, or device-independent units, so that the tiles are the same size across any display system, regardless of the number of pixels per inch (PPI) of a given display. In another example, the height and width of the tiles may be defined as a set number of pixels, so that a particular data item placed over the tiles will be sized for display according to the sum total of the number of pixels of the tiles the data item is covering. In other words, for a given data item, the space allocated for the display of the data item on any given display system is defined by the number of tiles the data item is covering as indicated in the display position instructions. Accordingly, a smaller display screen size will only be capable of displaying data items covering a small number of tiles relative to larger displays having greater pixel counts which can accommodate larger numbers of tiles. Note that when referring to pixels, it is assumed herein that pixels have a defined size. For example, each pixel could be defined as 0.18×0.18 millimeters (mm) in size. Accordingly, a given data item will be displayed at the same size regardless of the display system on which it is displayed. For example, a button having a size defined as 0.3 inches by 0.3 inches will appear at that size on any display system.

Computing system 110 processes the display position instructions to generate the customized display layout for the application (203). Computing system 110 is able to generate the customized display layout for the application based on the various data items and/or data display types arranged on the display screen over the tiles on the grid of the display composer interface as indicated in the display position instructions. As discussed above, the data display instructions could also include other customized display information such as sizes, shapes, styles, and other properties attributed to the data items and their associated data display types.

Based on the customized display layout, computing system 110 renders a graphical user interface to the application having the data items positioned according to the display position instructions, wherein the arrangement of the data items over the tiles dictates how the data items are positioned for a particular display size and orientation (204). For example, after designing the customized display layout, when the user launches the application, computing system 110 may render a graphical user interface to the application based on the customized display layout, which results in the data items positioned according to the display position instructions. The desired data items are thus displayed to the user in the selected data display types and arranged according to the position instructions, which provides the user with the most optimized and beneficial interface to the application for that particular user.

The arrangement of the data items over the tiles dictates how the data items are positioned for a particular display size and orientation. In other words, depending on the display size and orientation of the display system used to display the graphical user interface of the application, the arrangement of the data items can adapt to fit the constraints of the display system based on how the data items are arranged over the tiles. As discussed above, each tile in the grid corresponds to a certain amount of display screen area, which may be measured in pixels in some examples. Accordingly, a data item that only covers a single tile may be repositioned to another location on the display having the screen area or number of pixels allocated to a single tile, but a data item spanning multiple tiles could only be repositioned to another area of the screen having the display screen area sufficient to accommodate the multiple tiles covered by the data item. For example, a smartphone may have a smaller display size that only has the screen area needed to display a single tile horizontally in portrait mode, but may be able to display two or three tiles stacked vertically. In this case, if in the display position instructions two data items were each placed individually on single adjacent tiles horizontally across the display composer interface, the second data item would be automatically relocated to below the first data item in a vertical stack arrangement on the smartphone in portrait mode instead of being horizontally adjacent to the first data item as originally arranged in the position instructions. However, if the smartphone orientation was changed to landscape mode, the two data items could then be displayed in their original horizontally-adjacent arrangement, since the smartphone could accommodate the space for at least two tiles horizontally in that case. Again, larger display sizes could accommodate greater numbers of tiles and thus may not require any repositioning of the data items from the original arrangement as defined in the position instructions, and could possibly even accommodate multiple different customized display layouts for viewing data items for several machines or other industrial operations. In some implementations, the display position instructions could further indicate a group of the data items, and the arrangement of the group of the data items over the tiles dictates how the group of the data items is positioned collectively. In other words, a group of data items, or graphical elements, may be treated collectively as a single data item or graphical element with respect to placement over the tiles and the resulting tile coverage and corresponding display behavior on different display sizes as described herein.

Advantageously, the above techniques enable a user of an industrial automation application to design a customized display layout that may be used to render a graphical user interface to the application according to the user's specifications. By providing the display position instructions using the display composer interface, the user is able to fully customize the display of information when subsequently executing the industrial automation application. Further, by utilizing a grid of tiles on the display composer interface, the arrangement of the data items over the tiles dictates how the data items are positioned for a particular display size and orientation. In this manner, the techniques described herein provide the technical advantage of electronically storing customized display layouts of industrial information that may be used to render different graphical user interfaces to an industrial automation application for a multitude of display sizes. Further, by providing only the data items and data display types selected by an individual user when designing a customized display layout, the load on the processors, mechanical components, and other elements of an industrial automation environment may be reduced, resulting in significant energy savings by avoiding unnecessary operations. Accordingly, a user of an application in an industrial automation environment is presented with the data items arranged according to the user's specifications, which may then be repositioned for a particular display size and orientation based on the arrangement of the data items over the tiles, thereby optimizing the utility of the application for the user and greatly enhancing the user experience.

Several illustrative examples of various possible implementations of the above visualization techniques will now be discussed. The following examples as illustrated in FIGS. 3 through 9 could be executed by computing system 110 and other elements of industrial automation environment 100, and could also be combined with operation 200 of FIG. 2 in some implementations.

FIG. 3 is a block diagram that illustrates an operational scenario involving computing system 300 in an exemplary implementation. Computing system 300 includes display system 301, which in this example comprises a touch screen that displays a graphical user interface for the user to interact with and accepts input commands from the user via the user's touch on the surface of the touch screen. However, user input could be provided by a variety of different techniques in other examples, such as entering text commands with a keyboard, clicking a mouse pointer, speaking a voice command, or any other user input mechanism.

In FIG. 3, an exemplary display composer interface that enables a user to compose and edit custom displays is shown on display system 301, labeled “Create New Display”. In this example, the display composer interface includes two sections, divided into a menu on the left-hand side and a display composer on the right, although these windows could appear anywhere on the screen in other examples. The menu in the left-hand pane list various data items that may be selected to provide visualizations of operational data items, and the composer section in the right-hand pane provides a blank canvas that may be used to arrange the data items as the user desires them to be presented. In this example, the display composer canvas comprises a visualization of a grid of tiles onto which the user can insert and position various widgets that display operational data. The gridlines displayed in the composer canvas not only assist the user in positioning the various widgets and data items when designing a custom display layout, but may also be used to determine how the data items may be positioned for a particular display size and orientation based on the arrangement of the data items over the tiles.

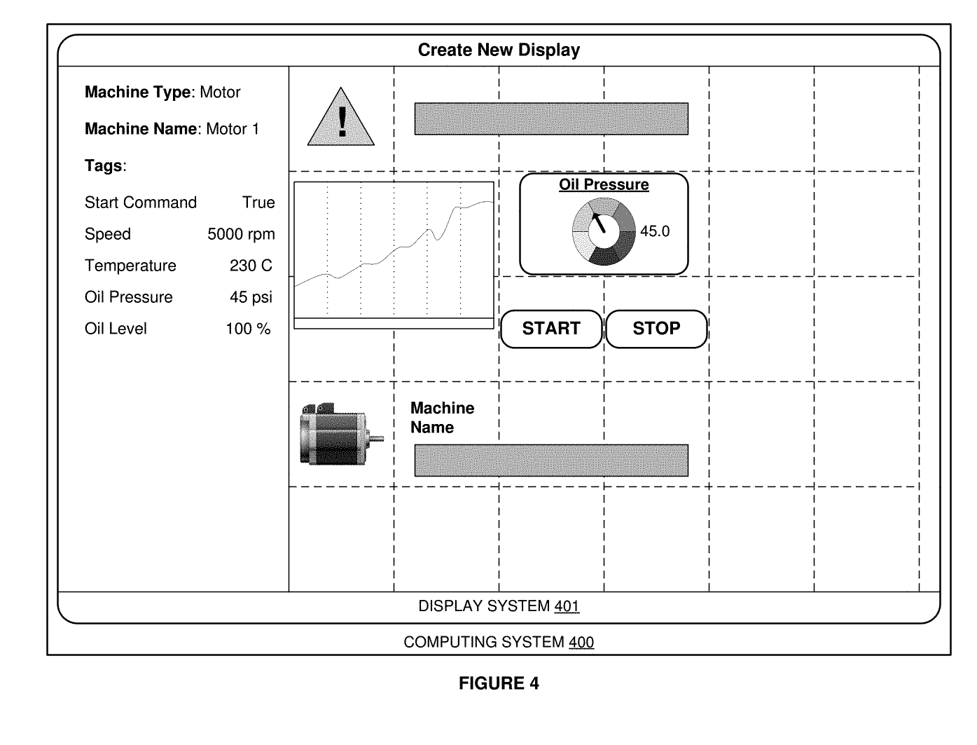

In this example, the user has selected to create a new display for a machine operating in an industrial automation environment. As shown in the menu on left-hand side of the display composer interface, identifying information about the machine is presented, such as the machine type of “Motor” and the machine name of “Motor 1”. In this case, the display layout being created is a general display for the machine type of “Motor”, but the user could create different custom display layouts that are unique to particular machines of the same type in some examples. Under the “Tags” heading, various data values are presented, including whether or not the motor has received a start command, speed, temperature, oil pressure, and oil level. Of course, the number and type of data values that are shown in FIG. 3 will differ depending on the type of model or machine selected; the ones shown in FIG. 3 are merely exemplary. The effect of the user selecting and arranging various data items to create a customized display layout will now be discussed with respect to FIG. 4.

FIG. 4 provides an operational scenario involving computing system 400 in an exemplary implementation. Computing system 400 includes display system 401. In this example, the user has arranged a number of data items over the tiles on the grid of the display composer interface to create a customized display layout for the “Motor” machine type. The user could create the display layout by selecting from the data tags and other information listed in the menu on the left-hand side of the composer interface and positioning them over the tiles on the grid as shown in the right-hand side of the display composer. Each of the data items could have a default data display type associated therewith that would appear when the user places a data item on the grid, such as a trend, gauge, button, value box, or some other display object. The user could also change the default display container type by editing properties of the object and selecting a different data display type from a menu. In some examples, the user could also first select from a menu of data display types to place a blank object of the type selected onto the grid, and then edit the properties of that object to assign a particular data source or value to that object, but this is not shown in FIG. 4 for clarity. For example, the user could select from data display types including indicators, value boxes, gauges, buttons, levers, control mechanisms, Scalable Vector Graphics (SVG) images, edge images, tanks, raster images, trends, trend reports, XY plot reports, maps, alarm grids, transaction grids, queries, test controls, and others. The user can further customize the display by resizing the object, defining custom display attributes and other properties, and positioning the object in a desired area of the display screen, among other functionality.

In this example, the user has positioned a warning alert indicator over the upper leftmost tile, represented by an exclamation point within a triangle. To the right of the warning indicator, a text box is positioned over three adjacent horizontal tiles, which may be used to display a warning, alarm, or some other kind of message. Beneath the warning indicator, the user has positioned a trend chart over a large square of four adjacent tiles, two in a horizontal direction and two in a vertical direction. To the right of the trend chart, an oil pressure gauge is positioned over two adjacent horizontal tiles. Beneath the oil pressure gauge, the user has positioned a start button on one tile and a stop button on another tile. At the bottom, an image of the motor is displayed on a single tile, along with the machine name to the right of the image, and a text box positioned over three adjacent horizontal tiles.

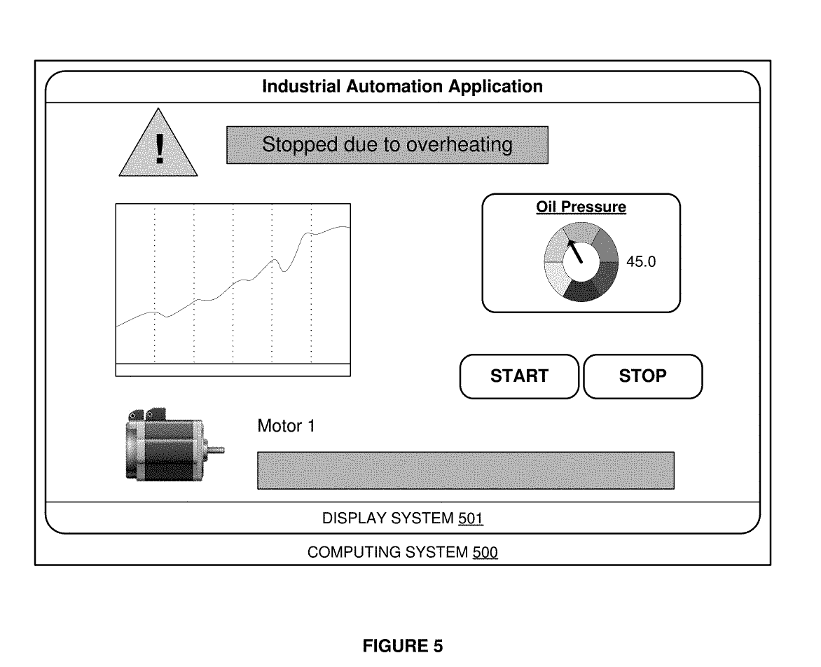

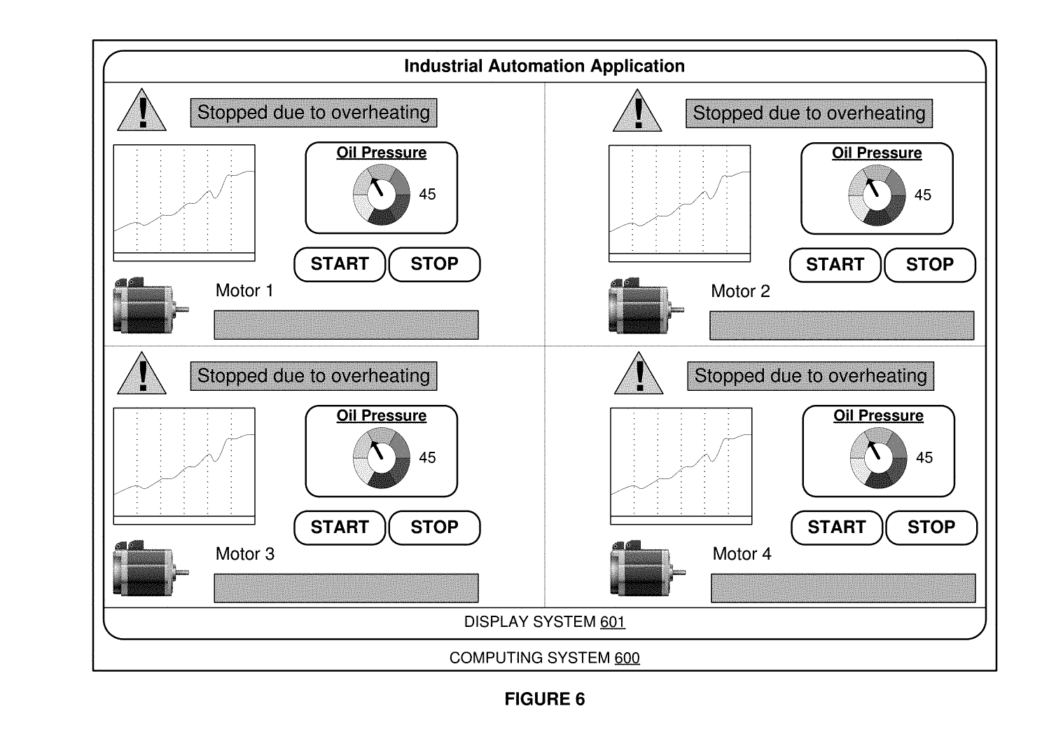

The arrangement of these data items over the tiles dictates how the data items may be positioned for different display sizes and orientations. When their original positions would not be visible due to screen resolution or orientation, data items that are only covering a single tile, such as the start and stop buttons, may be repositioned on smaller display sizes to any other area where a single tile is visible on the screen. For example, the stop button could be repositioned to the tile beneath the image of the motor on narrow display screens or a display oriented in portrait mode that would not otherwise have the space to display the stop button as originally positioned to the right of the start button. Likewise, items that cover multiple tiles cannot be broken up when repositioned, and must retain their arrangement and orientation over the tiles they cover. For example, the oil pressure gauge covers two adjacent horizontal tiles, so if the gauge needed to be repositioned so that it may be viewed on a smaller display size, the gauge could be moved to another set of two adjacent horizontal tiles, such as the two adjacent horizontal tiles below the image of the motor and the machine name data items. Some examples of how the customized display layout created by the user in this example as shown on display system 401 might appear on different display sizes will now be discussed with respect to FIGS. 5 and 6.

FIG. 5 provides an operational scenario involving computing system 500 in an exemplary implementation. Computing system 500 includes display system 501. Display system 501 is large enough to accommodate the display area necessary to display content that covers four horizontal tiles by four vertical tiles. Accordingly, all of the data items as arranged by the user on the display composer interface of FIG. 4 are shown on display system 501, since the customized display layout created in FIG. 4 does not exceed four tiles in either direction, as shown on display system 401.

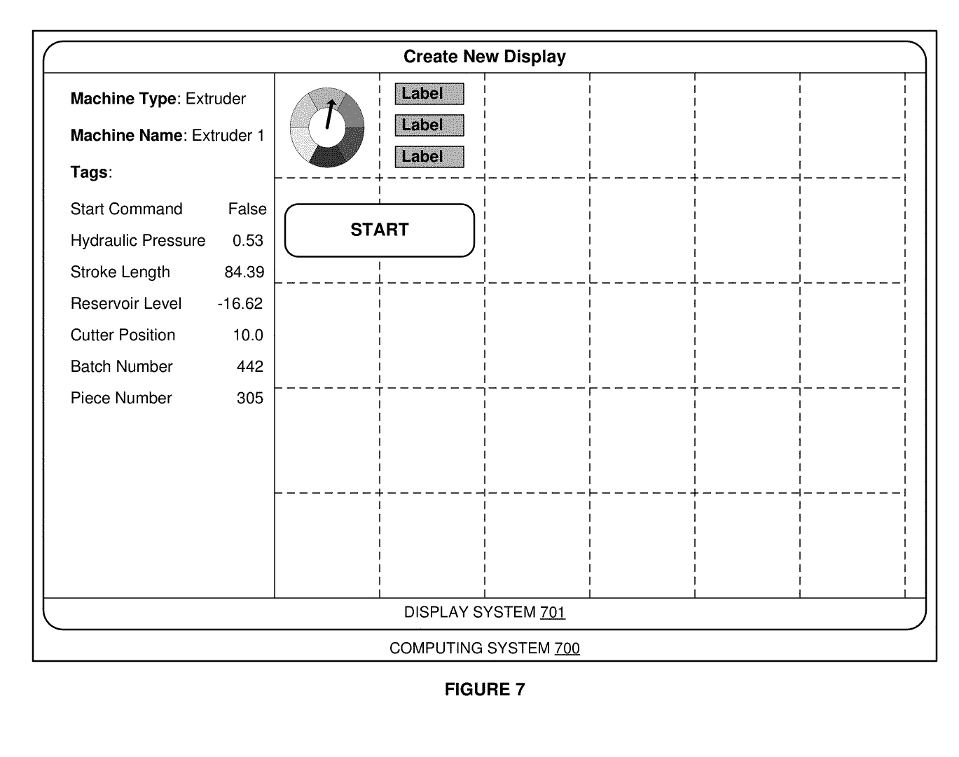

FIG. 6 provides an operational scenario involving computing system 600 in an exemplary implementation. Computing system 600 includes display system 601. In this example, display system 601 is larger than display system 501 of FIG. 5, and can accommodate the display area necessary to display content that covers sixteen horizontal tiles by sixteen vertical tiles. Accordingly, since the customized display layout created by the user on display system 401 is only four tiles wide by four tiles tall, four instances of this customized display layout are shown on display system 601 for four different machines of the same type, labeled “Motor 1”, “Motor 2”, “Motor 3”, and “Motor 4” in this example. For each instance of the customized display layout for each of the four motors, all of the data items as arranged by the user on the display composer interface of FIG. 4 are shown on display system 601, since the customized display layout created in FIG. 4 does not exceed four tiles in either direction, as shown on display system 401. Another example of a user selecting and arranging various data items on a display composer interface to create a customized display layout will now be discussed with respect to FIG. 7.

FIG. 7 provides an operational scenario involving computing system 700 in an exemplary implementation. Computing system 700 includes display system 701. In this example, the user is presented with a display composer interface to create a new display for a machine operating in an industrial automation environment. As shown in the menu on left-hand side of the display composer interface, identifying information about the machine is presented, such as the machine type of “Extruder” and the machine name of “Extruder 1”. Under the “Tags” heading, various data values are presented, including whether or not the extruder has received a start command, hydraulic pressure, stroke length, reservoir level, cutter position, batch number, and piece number. Of course, the number and type of data values that are shown on display system 701 will differ depending on the type of model or machine selected; the ones shown in FIG. 7 are merely exemplary.

On the right-hand side of the display composer interface, the user has arranged a number of data items over the tiles on the grid of the display composer interface to create a customized display layout for the “Extruder” machine type. In this example, the user has positioned a gauge over the upper leftmost tile. To the right of the gauge, three labels are stacked vertically and placed collectively on a single tile. Below these tiles, the user has placed a large start button spanning two adjacent horizontal tiles.

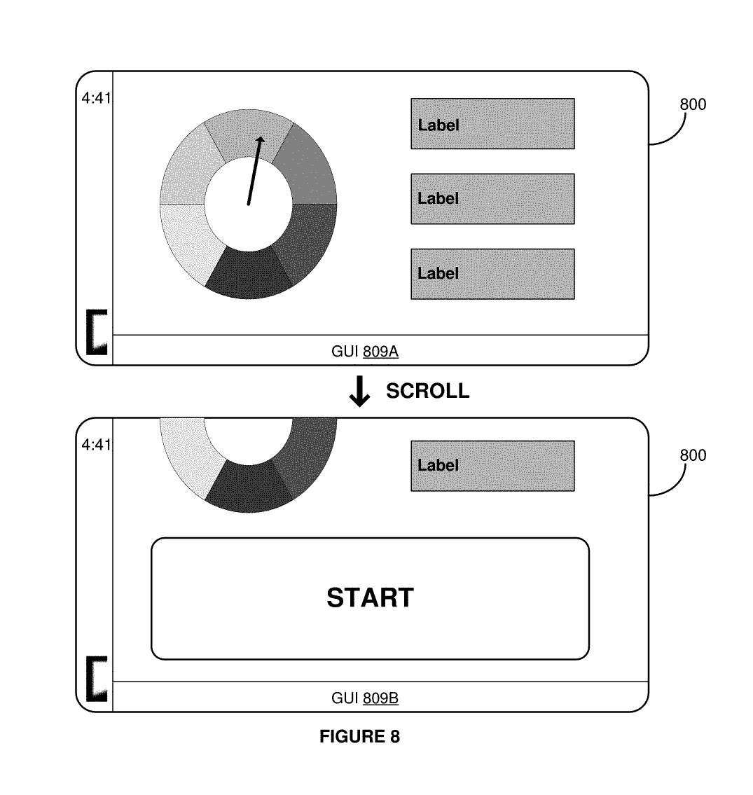

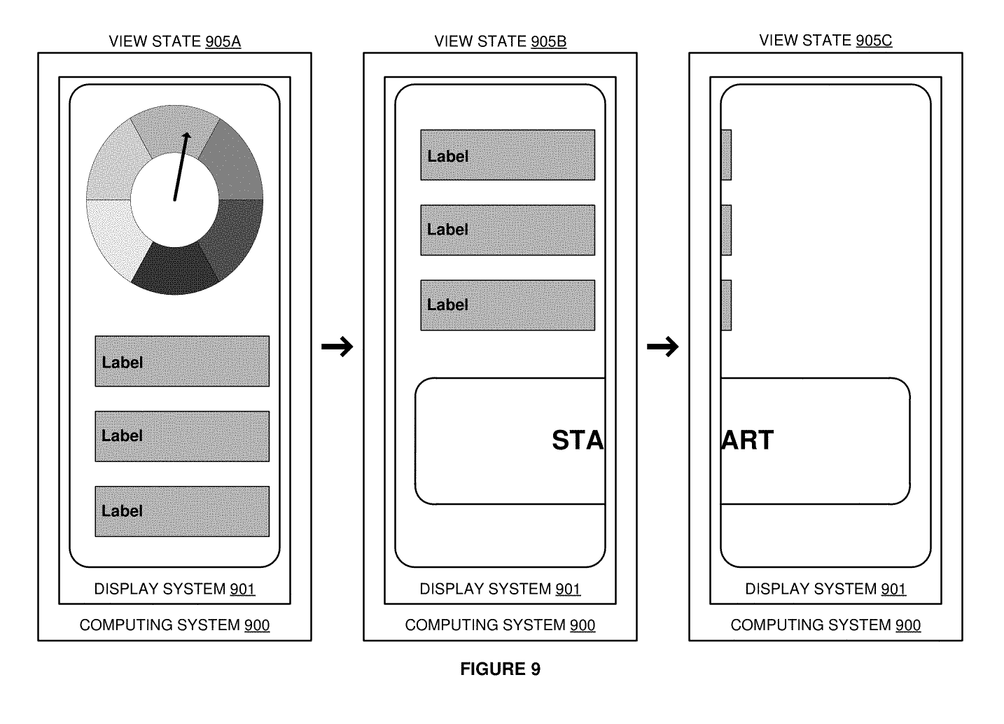

The arrangement of these data items over the tiles dictates how the data items may be positioned for different display sizes and orientations. Data items that are only covering a single tile, such as the gauge and the stack of labels, may be repositioned on smaller display sizes to any other area where a single tile is visible on the screen. However, items that cover multiple tiles cannot be broken up when repositioned, and must retain their arrangement and orientation over the tiles they cover. Some examples of how the customized display layout created by the user in this example as shown on display system 701 might appear on different display sizes will now be discussed with respect to FIGS. 8 and 9.

FIG. 8 provides an operational scenario involving computing system 800 in an exemplary implementation. Computing system 800 includes a display system that displays a graphical user interface (GUI) to the application. As shown in FIG. 8, computing system 800 is oriented in landscape mode, which can accommodate the display area necessary to display content that covers two horizontal tiles, but does not have space for any vertical tiles. Accordingly, when displaying the customized display layout shown on display system 701 as discussed above with respect to FIG. 7, the gauge and the stack of labels are shown on GUI 809A, but the start button is not visible. Instead, the user must scroll the display downward to view the start button, as shown in GUI 809B. This example also demonstrates how the number of tiles over which the content overlaps dictates the size of the items when displayed, since the width and height of each tile may be defined as a certain number of pixels.

FIG. 9 provides an operational scenario involving computing system 900 in an exemplary implementation. Computing system 900 includes display system 901. Computing system 900 is the same computing device as computing system 800 of FIG. 8, but in this example, computing system 900 is oriented in portrait mode, which can accommodate the display area necessary to display content that covers two vertically stacked tiles, but does not have space for any tiles in the horizontal direction. Accordingly, when displaying the customized display layout shown on display system 701 as discussed above with respect to FIG. 7, the gauge and the stack of labels are shown in a vertical column on view state 905A, and the start button is not initially visible. In this case, the stack of labels was repositioned to appear beneath the gauge instead of horizontally to the right of the gauge as originally arranged by the user on display system 701. This repositioning of the stack of labels occurs because in portrait mode, display system 901 does not have enough pixel width to display two tiles horizontally, and because the stack of labels was only covering a single tile, the stack of labels could be repositioned to the space below the gauge which can accommodate the single tile space needed to display the labels.

In view state 905B, the user has scrolled down to reveal the start button beneath the stack of labels. However, the start button is only partially visible in view state 905B. This is because the start button spans two adjacent tiles horizontally, but display system 901 in the portrait mode orientation only has enough display space for a single tile in the horizontal direction. Therefore, the user must scroll the screen to the right to view the other half of the start button, as shown in view state 905C. Beneficially, the arrangement of the data items over the tiles of the display composer interface provides the application with an adaptable display layout capable of automatically repositioning data items for a particular display size and orientation.

Referring now to FIG. 10, a block diagram that illustrates computing system 1000 in an exemplary implementation is shown. Computing system 1000 provides an example of computing system 110, although system 110 could use alternative configurations. Computing system 1000 includes processing system 1001, storage system 1003, software 1005, communication interface 1007, and user interface 1009. User interface 1009 comprises display system 1008. Software 1005 includes application 1006 which itself includes visualization process 200. However, in some implementations, visualization process 200 may optionally be implemented separately from application 1006, as shown by the dotted line around the graphical representation of process 200 appearing outside of application 1006.

Computing system 1000 may be representative of any computing apparatus, system, or systems on which application 1006 and visualization process 200 or variations thereof may be suitably implemented. Examples of computing system 1000 include mobile computing devices, such as cell phones, tablet computers, laptop computers, notebook computers, and gaming devices, as well as any other type of mobile computing devices and any combination or variation thereof. Note that the features and functionality of computing system 1000 may apply as well to desktop computers, server computers, and virtual machines, as well as any other type of computing system, variation, or combination thereof.

Computing system 1000 includes processing system 1001, storage system 1003, software 1005, communication interface 1007, and user interface 1009. Processing system 1001 is operatively coupled with storage system 1003, communication interface 1007, and user interface 1009. Processing system 1001 loads and executes software 1005 from storage system 1003. When executed by computing system 1000 in general, and processing system 1001 in particular, software 1005 directs computing system 1000 to operate as described herein for a visualization process or variations thereof. Computing system 1000 may optionally include additional devices, features, or functionality not discussed herein for purposes of brevity.

Referring still to FIG. 10, processing system 1001 may comprise a microprocessor and other circuitry that retrieves and executes software 1005 from storage system 1003. Processing system 1001 may be implemented within a single processing device but may also be distributed across multiple processing devices or sub-systems that cooperate in executing program instructions. Examples of processing system 1001 include general purpose central processing units, application specific processors, and logic devices, as well as any other type of processing device, combinations, or variations thereof.

Storage system 1003 may comprise any computer readable media or storage media readable by processing system 1001 and capable of storing software 1005. Storage system 1003 may include volatile and nonvolatile, removable and non-removable media implemented in any method or technology for storage of information, such as computer readable instructions, data structures, program modules, or other data. Storage system 1003 may be implemented as a single storage device but may also be implemented across multiple storage devices or sub-systems co-located or distributed relative to each other. Storage system 1003 may comprise additional elements, such as a controller, capable of communicating with processing system 1001. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the storage media a propagated signal.

In operation, in conjunction with user interface 1009, processing system 1001 loads and executes portions of software 1005, such as application 1006 and/or visualization process 200, to render a graphical user interface for application 1006 for display by display system 1008 of user interface 1009. Software 1005 may be implemented in program instructions and among other functions may, when executed by computing system 1000 in general or processing system 1001 in particular, direct computing system 1000 or processing system 1001 to present a display composer interface comprising tiles arranged in a grid that enables a user to design a customized display layout for an application associated with an industrial automation environment. Software 1005 may further direct computing system 1000 or processing system 1001 to receive display position instructions that indicate an arrangement of data items over the tiles on the grid of the display composer interface, wherein the data items are associated with operations of the industrial automation environment. Software 1005 may also direct computing system 1000 or processing system 1001 to process the display position instructions to generate the customized display layout for the application. In addition, software 1005 may direct computing system 1000 or processing system 1001 to, based on the customized display layout, render a graphical user interface to the application having the data items positioned according to the display position instructions, wherein the arrangement of the data items over the tiles dictates how the data items are positioned for a particular display size and orientation.

Software 1005 may include additional processes, programs, or components, such as operating system software or other application software. Examples of operating systems include Windows®, iOS®, and Android®, as well as any other suitable operating system. Software 1005 may also comprise firmware or some other form of machine-readable processing instructions executable by processing system 1001.

In general, software 1005 may, when loaded into processing system 1001 and executed, transform computing system 1000 overall from a general-purpose computing system into a special-purpose computing system customized to facilitate visualization of an application as described herein for each implementation. For example, encoding software 1005 on storage system 1003 may transform the physical structure of storage system 1003. The specific transformation of the physical structure may depend on various factors in different implementations of this description. Examples of such factors may include, but are not limited to the technology used to implement the storage media of storage system 1003 and whether the computer-storage media are characterized as primary or secondary storage.

In some examples, if the computer-storage media are implemented as semiconductor-based memory, software 1005 may transform the physical state of the semiconductor memory when the program is encoded therein. For example, software 1005 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 1000 is generally intended to represent a computing system with which software 1005 is deployed and executed in order to implement application 1006 and/or visualization process 200 (and variations thereof). However, computing system 1000 may also represent any computing system on which software 1005 may be staged and from where software 1005 may be distributed, transported, downloaded, or otherwise provided to yet another computing system for deployment and execution, or yet additional distribution. For example, computing system 1000 could be configured to deploy software 1005 over the internet to one or more client computing systems for execution thereon, such as in a cloud-based deployment scenario.

Communication interface 1007 may include communication connections and devices that allow for communication between computing system 1000 and other computing systems (not shown) or services, over a communication network 1011 or collection of networks. In some implementations, communication interface 1007 receives dynamic data 1021 over communication network 1011. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 1009 may include a voice input device, a touch input device for receiving a gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface 1009. In this example, user interface 1009 includes display system 1008, which itself may be part of a touch screen that also accepts user inputs via touches on its surface. The aforementioned user input devices are well known in the art and need not be discussed at length here. User interface 1009 may also include associated user interface software executable by processing system 1001 in support of the various user input and output devices discussed above. Separately or in conjunction with each other and other hardware and software elements, the user interface software and devices may provide a graphical user interface, a natural user interface, or any other kind of user interface.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a computing system to facilitate visualization of an application associated with an industrial automation environment, the method comprising:
presenting a display composer interface comprising tiles arranged in a grid that enables a user to design a customized display layout for the application associated with the industrial automation environment;
receiving display position instructions that indicate an arrangement of data items over the tiles on the grid of the display composer interface, wherein the data items are associated with operations of the industrial automation environment;
processing the display position instructions to generate the customized display layout for the application; and
based on the customized display layout, rendering a graphical user interface to the application having the data items positioned according to the display position instructions, wherein the arrangement of the data items over the tiles dictates how the data items are positioned for a particular display size and orientation.

2. The method of claim 1 wherein each of the data items are placed separately over one or more of the tiles on the grid of the display composer interface for the arrangement of the data items.

3. The method of claim 1 wherein the display position instructions further indicate a group of the data items, and wherein the arrangement of the group of the data items over the tiles dictates how the group of the data items is positioned collectively.

4. The method of claim 1 wherein the data items are associated with a type of machine operating in the industrial automation environment.

5. The method of claim 1 wherein the data items comprise a control mechanism that controls an operation of a machine in the industrial automation environment.

6. The method of claim 1 wherein the data items comprise human-machine interface content.

7. The method of claim 1 wherein the data items comprise a trend diagram associated with the operations of the industrial automation environment.

8. One or more computer-readable storage media having program instructions stored thereon to facilitate visualization of an application associated with an industrial automation environment, wherein the program instructions, when executed by a computing system, direct the computing system to at least:
present a display composer interface comprising tiles arranged in a grid that enables a user to design a customized display layout for the application associated with the industrial automation environment;
receive display position instructions that indicate an arrangement of data items over the tiles on the grid of the display composer interface, wherein the data items are associated with operations of the industrial automation environment;
process the display position instructions to generate the customized display layout for the application; and
based on the customized display layout, render a graphical user interface to the application having the data items positioned according to the display position instructions, wherein the arrangement of the data items over the tiles dictates how the data items are positioned for a particular display size and orientation.

9. The one or more computer-readable storage media of claim 8 wherein each of the data items are placed separately over one or more of the tiles on the grid of the display composer interface for the arrangement of the data items.

10. The one or more computer-readable storage media of claim 8 wherein the display position instructions further indicate a group of the data items, and wherein the arrangement of the group of the data items over the tiles dictates how the group of the data items is positioned collectively.

11. The one or more computer-readable storage media of claim 8 wherein the data items are associated with a type of machine operating in the industrial automation environment.

12. The one or more computer-readable storage media of claim 8 wherein the data items comprise a control mechanism that controls an operation of a machine in the industrial automation environment.

13. The one or more computer-readable storage media of claim 8 wherein the data items comprise human-machine interface content.

14. The one or more computer-readable storage media of claim 8 wherein the data items comprise a trend diagram associated with the operations of the industrial automation environment.

15. An apparatus to facilitate visualization of an application associated with an industrial automation environment, the apparatus comprising:
one or more computer-readable storage media; and
program instructions stored on the one or more computer-readable storage media that, when executed by a processing system, direct the processing system to at least:
present a display composer interface comprising tiles arranged in a grid that enables a user to design a customized display layout for the application associated with the industrial automation environment;
receive display position instructions that indicate an arrangement of data items over the tiles on the grid of the display composer interface, wherein the data items are associated with operations of the industrial automation environment;
process the display position instructions to generate the customized display layout for the application; and
based on the customized display layout, render a graphical user interface to the application having the data items positioned according to the display position instructions, wherein the arrangement of the data items over the tiles dictates how the data items are positioned for a particular display size and orientation.

16. The apparatus of claim 15 wherein each of the data items are placed separately over one or more of the tiles on the grid of the display composer interface for the arrangement of the data items.

17. The apparatus of claim 15 wherein the display position instructions further indicate a group of the data items, and wherein the arrangement of the group of the data items over the tiles dictates how the group of the data items is positioned collectively.

18. The apparatus of claim 15 wherein the data items are associated with a type of machine operating in the industrial automation environment.

19. The apparatus of claim 15 wherein the data items comprise a control mechanism that controls an operation of a machine in the industrial automation environment.

20. The apparatus of claim 15 wherein the data items comprise human-machine interface content.
